(19) United States
(12) Patent Application Publication
(10) Pub. No.: US 2009/0238478 A1
(43) Pub. Date: Sep. 24, 2009

(54) IMAGE PROCESSING APPARATUS

(76) Inventor: Masahiko Banno, Hyogo (JP)

Correspondence Address: DICKSTEIN SHAPIRO LLP, 1825 EYE STREET NW, Washington, DC, 20006-5403, US

(21) Appl. No.: 12/405,833

(22) Filed: Mar. 17, 2009

(30) Foreign Application Priority Data
Mar. 18, 2008 (JP) 2008-069307

(51) Int. Cl. G06K 9/36

(52) U.S. Cl. 382/233

(57) ABSTRACT

An image processing apparatus enables efficient access to image information and increases processing speed. A reading unit generates addresses of a plurality of pixels in a rectangular region of an image stored in an external storage unit with reference to an arbitrary pixel in the rectangular region based on the address of the arbitrary pixel in the external storage unit and the number of pixels in a main scan direction. The reading unit then reads the pixels of the rectangular region successively with reference to the generated addresses of the plural pixels in the rectangular region.

### BACKGROUND OF THE INVENTION

1. Field of the Invention

The present invention relates to image processing apparatuses in which image information is stored in a storage device such as a memory, and in which the image information is subjected to a predetermined process.

2. Description of the Related Art

There is a growing demand for image processing technologies that provide higher processing speed and better image quality. Achieving better image quality requires image information for more colors and more shades of grey. As a storage unit for such image information in an image processing apparatus, a large-capacity memory such as a single data rate (SDR) memory or a double data rate (DDR) memory is often used as a paging memory.

The increase in the amount of image information to be processed has a trade-off relationship with the attempt to increase processing speed. In order to find a good balance between them, a technology is required that allows efficient access to the image information.

Japanese Laid-Open Patent Application No. 2004-220584 discloses an image information processing apparatus in which a rectangular region partitioned in a main scan direction and a sub-scan direction is set on image data loaded on memory by a memory region control unit. Access to the region is enabled by an address information generating unit, wherein the rectangular region is accessed and data is read therefrom, and the data is then transferred to another memory by a direct memory access (DMA) control unit.

In this image information processing apparatus, burst access is performed in the region that is set. Thus, when accessing random points of regions in an image, a number of wasteful accesses are performed in regions other than a target region, resulting in a significantly lowered efficiency.

### SUMMARY OF THE INVENTION

It is an object of the present invention to provide an image processing apparatus in which image information can be accessed efficiently so that processing speed can be improved.

According to an aspect of the present invention, an image processing apparatus includes a storage unit in which information about an image having plural pixels arranged two-dimensionally in a main scan direction and a sub-scan direction is stored in an order in which the pixels are arranged; a reading unit configured to read the image information from the storage unit; a retaining unit configured to temporarily retain the image information read from the storage unit by the reading unit; a main-scan pixel number setting unit configured to provide the reading unit with a number of the pixels of the image in the main scan direction in advance; an address information setting unit configured to provide the reading unit with an address of an arbitrary one of the pixels of the image in the storage unit.

The reading unit generates addresses of a plurality of pixels in a rectangular region in the image with reference to the arbitrary pixel based on the address of the arbitrary pixel in the storage unit and the number of pixels in the main scan direction. The reading unit then reads the pixels of the rectangular region successively with reference to the generated addresses of the plural pixels in the rectangular region.

### BRIEF DESCRIPTION OF THE DRAWINGS

FIG. 1 shows a block diagram of an image processing apparatus according to an embodiment of the present invention;

FIG. 2 shows a block diagram of a configuration of processor element (PE) cores and a global processor (GP) of the image processing apparatus shown in FIG. 1;

FIG. 3 shows a block diagram of a memory controller of the image processing apparatus shown in FIG. 1;

FIG. 4 shows an arrangement of image information in an external memory;

FIG. 5 shows a flow of data between an SIMD microprocessor and an external memory according to an embodiment of the present invention; and

FIG. 6 shows an area from which image information is read at the time of image rotation.

### DETAILED DESCRIPTION OF THE PREFERRED EMBODIMENTS

Embodiments of the present invention are described with reference to the drawings.

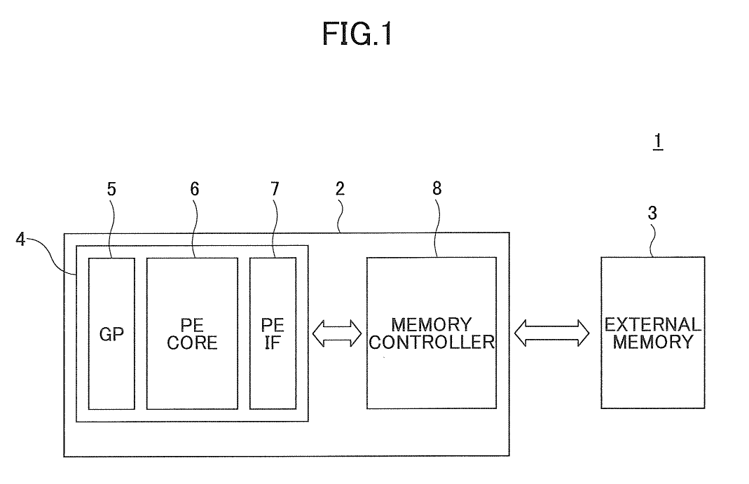

FIG. 1 shows a block diagram of an image processing apparatus 1 according to an embodiment of the present invention. The image processing apparatus 1 includes a single instruction, multiple data (SIMD) microprocessor 2 and an external memory 3. The SIMD microprocessor 2 includes a processor unit 4 and a memory controller 8. The processor unit 4 includes a global processor (GP) 5, a processor element (PE) core 6, and a PE interface (PEIF) 7.

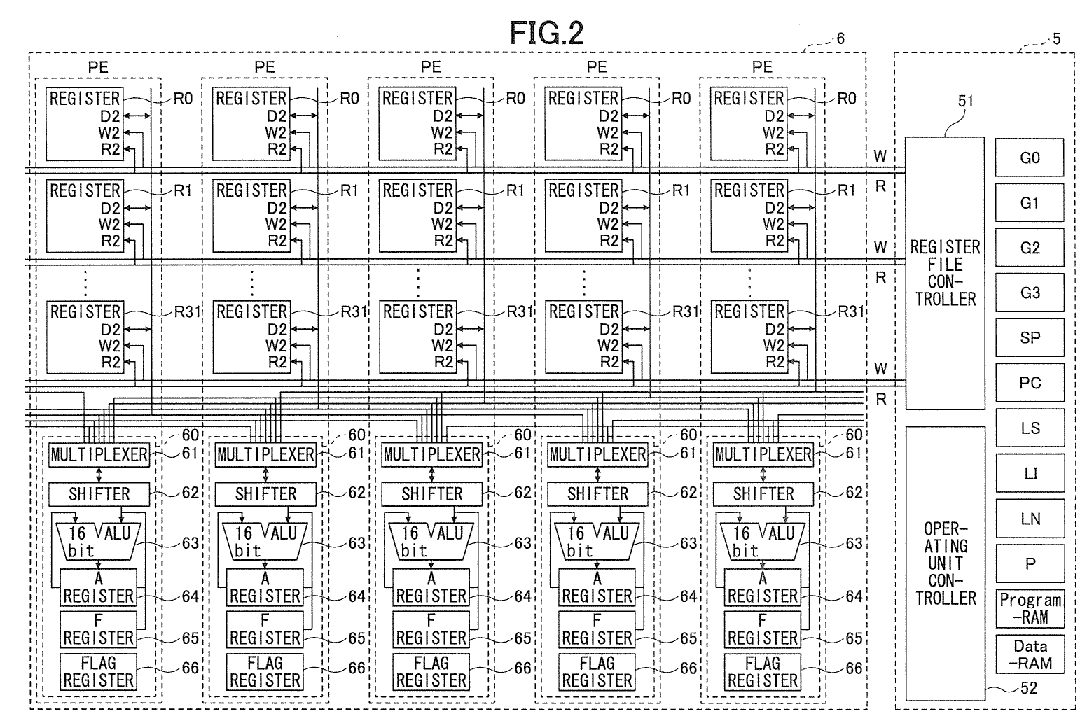

Referring to FIG. 2, the GP 5, which provides a main-scan pixel number setting unit, is a single instruction, single data (SISD) processor. The GP 5 contains a program random access memory (RAM) for storing a program for the SIMD microprocessor 2 and a data RAM for storing operating data.

The GP 5 further includes a program counter (PC) for retaining program addresses; registers G0 to G3 which are general-purpose registers for storing data for operating processes; a stack pointer (SP) that retains save addresses in the data-RAM for register save and return; a link register (LS) that retains a calling address at the time of a sub-routine call; LI and LN registers for retaining a branching address at the time of an interrupt request (IRQ) or a non-maskable interrupt (NMI), and a processor status register (P) that retains a status of the processor.

Using these registers and an instruction decoder, as well as an arithmetic operating circuit (ALU), a memory control circuit, an interrupt control circuit, an external I/O control circuit, and a GP operation control circuit that are not shown, a GP instruction is executed. Upon execution of a PE instruction, which is an instruction that involves the PE core 6 as will be described later, register files and operating arrays in the PE core 6 are controlled using the register file control circuit 51 and the operating unit control circuit 52.

The PE core 6, which is an address information setting unit, includes a plurality of processor elements (PE). Each of the PE's includes a register file and an operating unit 60. The register file is composed of 32 8-bit registers R0 to R31 as shown in FIG. 2.

The register files retain data that is processed in connection with a PE instruction. The PE instruction is of the SIMD type for performing the same process on data retained in the register files in multiple PE's. Reading and writing of data from or to the register files are controlled by a control signal from the register file control circuit 51 in the GP 5. Data that is read is sent to the operating unit 60 where it is operated and then written in the register file. The register files can be accessed from outside the processor unit 4, so that a specific register can be externally read from or written into, separately from the control by the GP 5.

The use of the SIMD microprocessor allows the number of processing steps to be greatly reduced by parallel processing by processor elements, so that more image processing can be realized with the same volume of codes.

As mentioned above, the register file of each PE includes the 32 8-bit registers, and the registers of the entire PE's form an array. For example, when there are 256 PE's, the 256 PE's form an array. The 8-bit registers are referred to as R0, R1, R2, . . . , and R31 in each PE. Each register has one read port and one write port for the operating unit 60, and is accessed by the operating unit 60 via an 8-bit read/write bus.

A plurality of the 32 registers can be accessed from outside the processor unit 4, so that arbitrary registers can be read from or written into by inputting clock, address, and read/write control signals from the outside. When accessing from outside the register, an individual register in each PE can be accessed via one external port by designating a PE number (such as from 0 to 255) using an externally inputted address. Using this port, a memory controller 8 accesses the external memory 3, as will be described below.

The operating unit 60 performs an operation process in response to a PE instruction. The process is entirely controlled from the operating unit control circuit 52 in the GP 5. The operating unit 60 includes a multiplexer 61, a shifter 62, a 16-bit arithmetic logic unit (ALU) 63, an A register 64, an F register 65, and a flag register 66. The operating units 60 of the entire PE's form an array structure (which may also be called an “operation array”).

The multiplexer 61 is capable of selecting data 1, 2, or 3 PE's away to the left, data 1, 2, or 3 PE's away, or central data as an operation target. The shifter 62 performs bit shifting and bit extension on the data read from the register file. The ALU 63 performs an operation on data entered from the shifter 62 and the A register 64 and outputs a result to the A register 64. The A register 64 is an accumulator for storing the result obtained by the operation in the ALU 63.

Thus, basically in the operating unit 60, the data read from the register file is supplied to one input of the ALU 63, while the content of the A register 64 is fed to the other input, and the result is stored in the A register. Thus, operations are performed between the A register and the registers R0 to R31. Further, validity/invalidity of execution of an operation is controlled by an 8-bit conditional register (T) (not shown) for each PE so that a specific PE can be selected as an operation target.

The PEIF 7 controls external access to the register files in the processor unit 4.

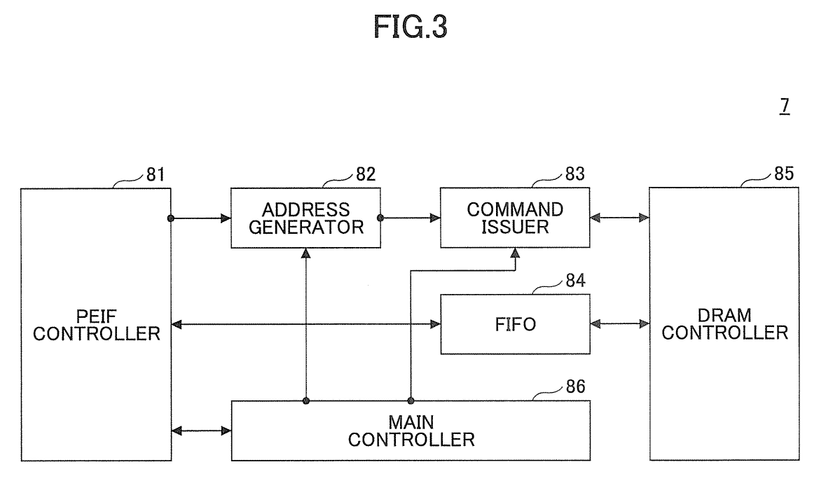

Referring to FIG. 3, the memory controller 8, which is a reading unit, includes a PEIF controller 81, an address generating unit 82, a command issuing unit 83, a FIFO unit 84, a dynamic RAM (DRAM) controller 85, and a main control unit 86.

The PEIF controller 81 is configured to generate address, access clock, and read/write control signals for the register files in the PE core 6, and may include a data input/output buffer unit.

The address generating unit 82 generates access start address information and send it to the command issuing unit 83 under the control of the main control unit 86, as will be described later.

The command issuing unit 83 outputs a read or write command to the DRAM controller 85, a logic address on the external memory 3 as an access start address, and an access burst number that is a number of successive accesses.

The FIFO (First In First Out) unit 84 provides a buffer for managing the input and output of data to or from the DRAM controller 85 or the PEIF controller 81. The FIFO unit 84 may include a FIFO memory and a register file.

The DRAM controller 85 controls the external memory 3. The DRAM controller 85 accesses the external memory 3 by acquiring information from the command issuing unit 83, such as the read or write command, the logic address on the external memory 3 as an access start address, and the access burst number.

The main control unit 86 controls the memory controller 8 generally. The main control unit 86 operates in accordance with an instruction from the GP unit.

The external memory 3, which is a storage unit, may include a memory capable of burst access, such as a single data rate synchronous dynamic RAM (SDR-SDRAM) or a double data rate synchronous dynamic RAM (DDR-SDRAM). The external memory 3 is used as a paging memory for storing image information processed by the SIMD microprocessor 2.

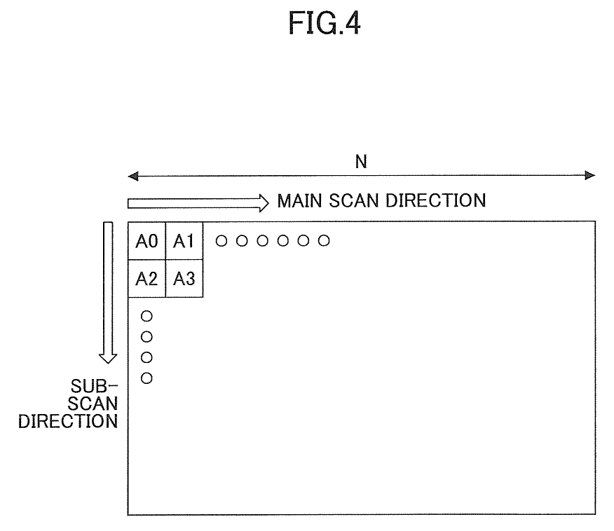

FIG. 4 shows an arrangement of the image information on the external memory 3. In the illustrated example, the image information contains multivalued information having 8 bits per pixel, where pixel information (data) is disposed in a burst direction in which successive addresses are present in the sub-scan direction on a byte by byte basis. The first line of image information is followed in the sub-scan direction by the second line of successive data. In this case, in order to simplify the memory access address management, the second line of data may be started from a position on the memory that is appropriate in terms of alignment.

In the example of FIG. 4, A0, A1, A2, and A3 indicate individual pixels. For example, the pixels A0 and A1 in the first line and the pixels A2 and A3 in the second line in the main scan direction correspond to data in a 2×2=4 pixel rectangular region.

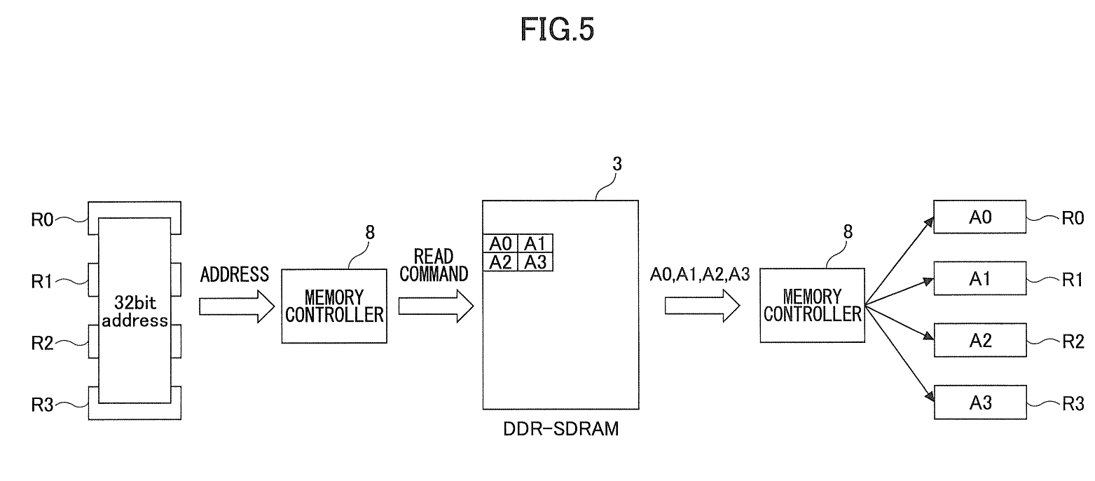

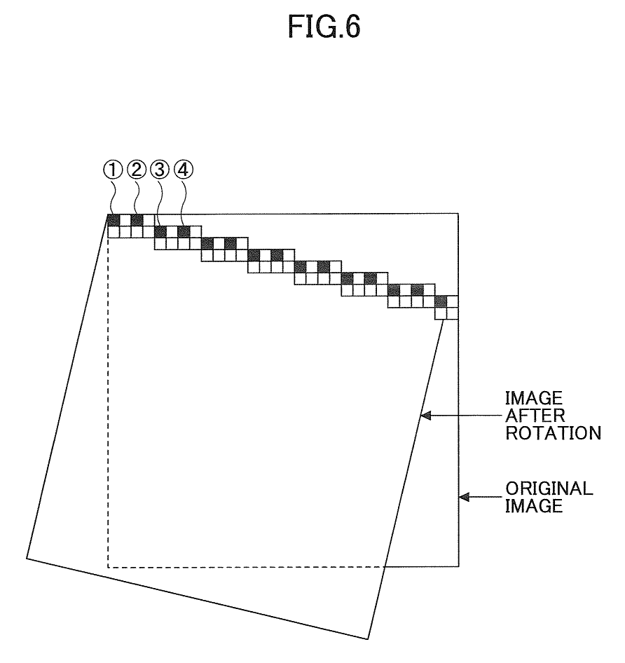

With reference to FIGS. 5 and 6, a process of reading information from a predetermined rectangular region in the image processing apparatus 1 is described.

Referring to FIG. 5, R0, R1, R2, and R3 indicate registers in a register file in the PE. In the present embodiment, four registers are used. The address of a pixel of interest in a 2×2 rectangular region on the external memory 3 that needs to be accessed is provided in the four registers, using the 8 bit×4=32 bits. For example, the address of the pixel of interest A0 in the upper-left corner of the 2×2 region in FIG. 4 is provided. Thus, the address of an arbitrary pixel in the storage unit is stored in the registers in the microprocessor.

The address of the point A0 is determined by an operation in the processor unit 4. In the SIMD microprocessor 2, the most efficient process is when a certain address operation formula is applied to the PE's 0 to 255 uniformly. For example, when a process for rotating a current image at a certain angle is considered, the image information after rotation has a sub-pixel position (between pixels) that does not exist in the current image information.

In this case, the sub-pixel position is determined by bilinear interpolation, for example. Bilinear interpolation requires referencing a rectangular region of 2×2 pixels in the current image. Because the positions of the 2×2 pixels are moved in the main scan direction and the sub-scan direction at a certain ratio, original address data is placed in PE 0 to PE 255 in the case of 256 PE's, and the address of the pixel of interest in the desired 2×2 pixel image region is prepared by operating the original address data. FIG. 6 also shows the pixels of interest after rotation. After the operation, address (1) is stored in the PE 0, address (2) is stored in the PE 1, address (3) is stored in PE 3, and address (4) is stored in the PE 4, . . . , and so on successively.

The addresses thus provided are then read by the PEIF controller 81 of the memory controller 8 sequentially and transmitted to the address generating unit 82 as the start address of the two pixels in the first line of the 2×2 pixel region. The address generating unit 82 then instructs the command issuing unit 83 to issue a read command for the two pixels in the first line, and adds the number of pixels in the main scan direction for the first line that is set in the memory controller 8 in advance by the GP 5, thereby calculating the start address for the second line. The address generating unit 82 then instructs the command issuing unit 83 to issue a read command for the two pixels in the second line.

In this way, the 2×2 pixels can be accessed at once based on the address of the single pixel of interest. By repeating this process, the 2×2 pixel regions following the pixel region (2) can also be accessed. Thus, the reading unit (memory controller 8) generates the addresses of a plurality of pixels in a rectangular region within an image with respect to an arbitrary reference pixel, based on the address of the arbitrary pixel in the storage unit and the number of pixels in the main scan direction. The reading unit then reads the pixels of the rectangular region successively with reference to the generated addresses.

The individual accesses that are made on the 2×2 pixel unit basis ((1), (2), (3), . . . , etc. in FIG. 6) do not need to be successive in the main scan direction or the sub-scan direction. Rather, random 2×2 pixel rectangular regions can be successively accessed.

The 2×2 image data that has been read by the read access, namely, the 32 bit image information in the present case, is written back as is into the register files in the processor unit 4 via the FIFO unit 84, the PEIF controller 81, and the PEIF 7, so that subsequent image processing can be performed efficiently. Specifically, addresses originally placed in the registers are overwritten and replaced with the image information, as shown in FIG. 5. In this way, the subsequent image processing can be efficiently performed by an SIMD process.

Thus, the registers R0 to R31 are used both as a retaining unit and as an address information setting unit. Namely, the reading unit (memory controller 8) acquires an address from the registers, reads image information from the storage unit (external memory 3) with reference to the address, and then stores the image information in the registers.

Thus, in accordance with the present embodiment, when the SIMD microprocessor 2 reads image information of a 2×2 rectangular region stored in the external memory 3, the address in the external memory 3 of the reference pixel positioned at the upper-left of the rectangular region is determined by an operation in the processor unit 4. The start of the second line is determined by adding the number of pixels in the main scan direction to the address of the reference pixel in the memory controller 8, and each line is read by a burst access. Thus, the large number of wasteful burst accesses that has been the case when accessing random rectangular regions in a conventional storage unit such as a memory can be eliminated and efficient access can be provided. Thus, the present embodiment can increase the image processing speed.

Furthermore, because the register where the address had been placed is overwritten with the image information read from the external memory, the subsequent image processing can be efficiently performed by the SIMD process.

While the foregoing embodiment has been described with reference to a process involving an image rotation, embodiment is merely exemplary and the present invention can be applied to any process in which a predetermined rectangular region within an image needs to be acquired.

Although this invention has been described in detail with reference to certain embodiments, variations and modifications exist within the scope and spirit of the invention as described and defined in the following claims.

The present application is based on the Japanese Priority Application No. 2008-069307 filed Mar. 18, 2008, the entire contents of which are hereby incorporated by reference.

What is claimed is:

1. An image processing apparatus comprising:
a storage unit in which information about an image having plural pixels arranged two-dimensionally in a main scan direction and a sub-scan direction is stored in an order in which the pixels are arranged;
a reading unit configured to read the image information from the storage unit;
a retaining unit configured to temporarily retain the image information read from the storage unit by the reading unit;
a main-scan pixel number setting unit configured to provide the reading unit with a number of the pixels of the image in the main scan direction in advance;
an address information setting unit configured to provide the reading unit with an address of an arbitrary one of the pixels of the image in the storage unit,
wherein the reading unit is configured to generate addresses of a plurality of pixels in a rectangular region in the image with reference to the arbitrary pixel based on the address of the arbitrary pixel in the storage unit and the number of pixels in the main scan direction, and configured to read the pixels of the rectangular region successively with reference to the generated addresses of the plural pixels in the rectangular region.

2. The image processing apparatus according to claim 1, wherein the main-scan pixel number setting unit and the address information setting unit include a microprocessor.

3. The image processing apparatus according to claim 2, wherein the address of the arbitrary pixel in the storage unit is stored in a register in the microprocessor.

4. The image processing apparatus according to claim 3, wherein the retaining unit is provided by the register in the microprocessor,
wherein the reading unit is configured to read the image information from the storage unit by acquiring the address of the arbitrary pixel in the storage unit from the register, and configured to store the image information that is read from the storage unit in the register.

5. The image processing apparatus according to claim 2, wherein the microprocessor includes a single instruction multiple data (SIMD) microprocessor having a number m (m is a natural number of 2 or more) of processor elements.
